(19) United States
(12) Patent Application Publication
(10) Pub. No.: US 2026/0278016 A1
(43) Pub. Date: Sep. 17, 2026

(54) MATERIAL CONTENT EXTRACTION METHOD, APPARATUS, DEVICE, MEDIUM, AND PRODUCT

(71) Applicant: Beijing Youzhuju Network Technology Co., Ltd., Beijing (CN)

(72) Inventors: Peiyu SUN, Beijing (CN); Ruichao TIAN, Beijing (CN); Tianrui YANG, Beijing (CN)

(21) Appl. No.: 19/537,402

(22) Filed: Feb. 11, 2026

(30) Foreign Application Priority Data
Mar. 13, 2025 (CN) 202510301155.7

(51) Int. Cl. G06F 16/9535; G06F 16/248

(52) U.S. Cl. CPC G06F 16/9535; G06F 16/248

(57) ABSTRACT

The present application discloses a material content extraction method and apparatus, a device, a medium, and a product. The method includes: displaying a content editing page, where the content editing page includes a keyword editing control; generating a keyword of a target object to be delivered in response to a trigger operation generated for the keyword editing control; searching for at least one piece of candidate material content matching the target object according to the keyword and displaying the at least one piece of candidate material content in a content expression region of the content editing page in the form of a card, where the candidate material content includes video content and text content; and extracting target material content matching the target object in response to a view operation for the candidate material content in the card.

### CROSS-REFERENCE TO RELATED APPLICATIONS

This application claims priority to Chinese Patent Application No. 202510301155.7, entitled “MATERIAL CONTENT EXTRACTION METHOD, APPARATUS, DEVICE, MEDIUM, AND PRODUCT”, and filed on Mar. 13, 2025. The entire disclosure of the prior application is hereby incorporated by reference in its entirety.

### TECHNICAL FIELD

The present disclosure relates to the technical field of data visualization processing, and in particular, to a material content extraction method, an apparatus, a device, a medium, and a product.

### BACKGROUND

With the development of Internet technology and computer technology, more and more applications support explaining an item to be published or delivered in a visual way such as video shooting, which is particularly important for the e-commerce field. However, since the feature points of certain items are relatively fixed, users are faced with a shortage of feature point display materials. Although some platforms provide a function of viewing high-performing feature point materials, they can only be viewed, and video materials and text materials are presented separately, making it difficult for users to implement the materials.

### SUMMARY

In view of this, the present disclosure provides a material content extraction method, an apparatus, a device, a medium, and a product.

In a first aspect, the present disclosure provides a material content extraction method, including: displaying a content editing page, where the content editing page includes a keyword editing control; generating a keyword of a target object to be delivered in response to a trigger operation generated for the keyword editing control; searching for at least one piece of candidate material content matching the target object according to the keyword and displaying the at least one piece of candidate material content in a content expression region of the content editing page in a form of a card, where the candidate material content includes video content and text content; and extracting target material content matching the target object in response to a view operation for the candidate material content in the card.

In a second aspect, the present disclosure provides a material content extraction apparatus, including: a page display module, configured to display a content editing page, where the content editing page includes a keyword editing control; a keyword generation module, configured to generate a keyword of a target object to be delivered in response to a trigger operation generated for the keyword editing control; a search module, configured to search for at least one piece of candidate material content matching the target object according to the keyword and display the at least one piece of candidate material content in a content expression region of the content editing page in a form of a card, where the candidate material content includes video content and text content; and an extraction module, configured to extract target material content matching the target object in response to a view operation for the candidate material content in the card.

In a third aspect, the present disclosure provides a computer device, including: a memory and a processor, where the memory and the processor are communicatively connected to each other, the memory stores computer instructions, and the processor executes the computer instructions to implement the material content extraction method according to the above first aspect or any corresponding implementation thereof.

In a fourth aspect, the present disclosure provides a computer-readable storage medium, where the computer-readable storage medium stores computer instructions, and the computer instructions are used to cause a computer to perform the material content extraction method according to the above first aspect or any corresponding implementation thereof.

In a fifth aspect, the present disclosure provides a computer program product, including computer instructions, where the computer instructions are used to cause a computer to perform the material content extraction method according to the above first aspect or any corresponding implementation thereof.

### BRIEF DESCRIPTION OF THE DRAWINGS

In order to illustrate the technical solutions in the specific embodiments of the present disclosure or in the related art more clearly, the following will briefly introduce the drawings that need to be used in the description of the specific embodiments or the related art. Obviously, the drawings in the following description are some embodiments of the present disclosure. For those of ordinary skill in the art, other drawings may be obtained based on these drawings without creative efforts.

FIG. 1 is a schematic flowchart of a material content extraction method according to an embodiment of the present disclosure;

FIG. 2 is a partial schematic diagram of a content editing page according to an embodiment of the present disclosure;

FIG. 3 is a schematic diagram of a card of candidate material content according to an embodiment of the present disclosure;

FIG. 4 is a schematic flowchart of another material content extraction method according to an embodiment of the present disclosure;

FIG. 5 is a schematic diagram of displaying a start time point and a playback progress bar according to an embodiment of the present disclosure;

FIG. 6 is a schematic diagram of selecting a playback progress bar with a frame according to an embodiment of the present disclosure;

FIG. 7 is a schematic diagram of pagination of text segments according to an embodiment of the present disclosure;

FIG. 8 is a schematic diagram of displaying the exposure count according to an embodiment of the present disclosure;

FIG. 9 is a schematic flowchart of another material content extraction method according to an embodiment of the present disclosure;

FIG. 10 is a schematic diagram of controls for adding a reference, copying, and material details according to an embodiment of the present disclosure;

FIG. 11 is a schematic diagram of content generation according to an embodiment of the present disclosure;

FIG. 12 is a structural block diagram of a material content extraction apparatus according to an embodiment of the present disclosure; and

FIG. 13 is a schematic hardware structural diagram of a computer device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and comprehensively with reference to the drawings in the embodiments of the present disclosure. Obviously, the described embodiments are part of the embodiments of the present disclosure, rather than all of them. All other embodiments obtained by those skilled in the art based on the embodiments of the present disclosure without creative efforts shall fall within the protection scope of the present disclosure.

It may be understood that before using the technical solutions disclosed in the embodiments of the present disclosure, users shall be informed of the type, range of use, use scenarios, etc., of personal information involved in the present disclosure and their authorization shall be obtained, all in an appropriate manner in accordance with relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to select whether to “agree” or “disagree” to provide the personal information to the electronic device.

It may be understood that the above process of notifying and obtaining user authorization is only illustrative and does not limit the implementations of the present disclosure, and other methods that satisfy relevant laws and regulations may also be applied in the implementations of the present disclosure.

It may be understood that the data involved in the technical solutions (including but not limited to the data itself, acquisition or use of the data) shall comply with the requirements of corresponding laws, regulations, and related provisions.

At present, among the videos delivered in major applications, there is a lack of ideas for displaying item feature points. Specifically, the feature point information of a single product or limited category products is relatively fixed, and users will still face the problem of lack of ideas for displaying feature points in the case of self-producing materials or creating materials through tools, which will seriously hinder the improvement of the quality and quantity of users' material creation. Taking the food and beverage “Food A” as an example, if the user only has this product and has shot more than 700 videos in a year, there are currently no more shooting ideas at all.

Based on this, the present disclosure provides a material content extraction method, an apparatus, a device, a medium, and a product to solve the problem of poor material implementation effect. The material creation team may successfully implement the feature point display offline, but the large-scale promotion to users is completely dependent on manual hand-holding, resulting in low efficiency of material implementation and difficulty in achieving scalability.

The material content extraction method, the apparatus, the device, the medium, and the product provided by the present disclosure support editing keywords on the content editing page, so that the corresponding candidate material content can be searched for by using the keywords, and the matching degree between the candidate material content and the keywords is ensured. By displaying each piece of candidate material content in the content expression region in the form of a card, the information carried by the candidate material content can be better organized, the information integrity of the candidate material content is ensured, and it is convenient for users to get inspiration from it. At the same time, displaying each piece of candidate material content in the form of a card is beneficial to improving the screen utilization. Then, by viewing the candidate material content in the card, it is convenient for the user to make a comparison and reference to extract inspiration from it, and obtain the target material content that matches the target object most. In this way, the visual extraction of the material content is realized, the efficiency of implementing the material content is greatly improved, and it is convenient for the user to effectively edit the delivery content of the target object according to the target material content, which helps to improve the delivery effect of the target object.

In order to achieve scalability, relevant content is displayed to users through various platforms. However, although each platform may display high-performing feature points to users through a feature point label strategy, users may only view corresponding videos and text scripts, and it is difficult to present the videos and text scripts in a comparison on the same screen, resulting in fragmentation in understanding. Moreover, the display pages of the videos and text scripts often have too much white space, which affects the efficient communication of information and visual compactness. When a feature point is mentioned multiple times in the same video clip, there is a lack of multiple-clip video support. After the user obtains inspiration input, there is no corresponding next operation, and operative operations are lacking.

Based on this, the technical solution of the present disclosure displays the corresponding candidate material content on the content editing page in the form of a card, which ensures a close association between a video and text, supports extracting required content from the candidate material content, and promotes material implementation.

According to an embodiment of the present disclosure, an embodiment of a material content extraction method is provided. It should be noted that the steps shown in the flowchart of the drawings may be executed in a computer system such as a set of computer executable instructions. Moreover, although a logical order is shown in the flowchart, in some cases, the steps shown or described may be executed in an order different from that herein.

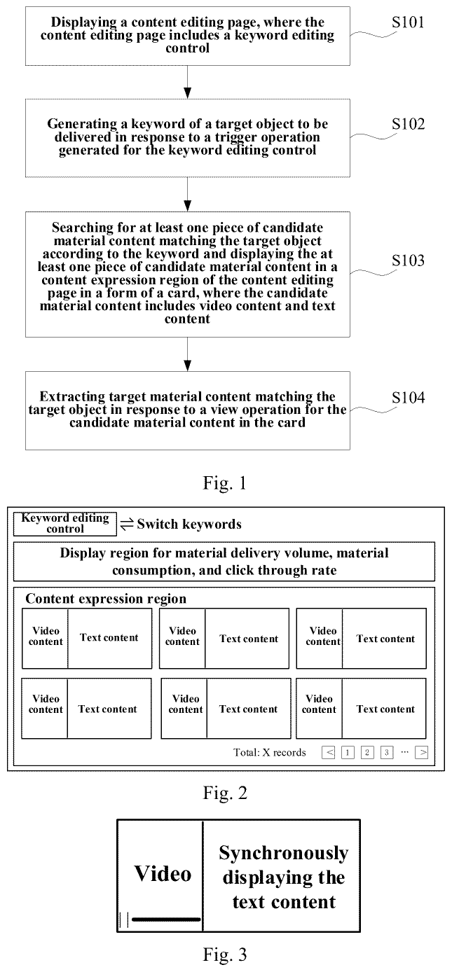

In this embodiment, a material content extraction method is provided, which may be applied to computer devices, such as mobile phones, tablets, computers, etc. FIG. 1 is a flowchart of a material content extraction method according to an embodiment of the present disclosure. As shown in FIG. 1, the process includes the following steps.

Step S101: displaying a content editing page, where the content editing page includes a keyword editing control.

The content editing page is an interactive page for the user to perform visual content editing. Specifically, a content editing tool is deployed in the computer device, and the content editing page is an interactive page provided by the content editing tool to the user, so that the user may perform content editing and visual content generation through the content editing page.

The keyword editing control is used to execute an editing instruction of the user to generate a corresponding content keyword, and the keyword editing control may be displayed at the top of the content editing page, as shown in FIG. 2. Certainly, the keyword editing control may also be arranged at other positions of the content editing page, which is not specifically limited here.

Step S102: generating a keyword of a target object to be delivered in response to a trigger operation generated for the keyword editing control.

The trigger operation is a click operation of the user on the keyword editing control. When the user clicks on the keyword editing control, the keyword editing control may display a keyword editing area, and the user may edit keywords for the target object to be visually generated in the keyword editing area to obtain the corresponding keywords. The visual generation means equipping the filmed target object with corresponding content to form a multimedia video containing keyword description and the target object; the target object is any item, such as an accessory, a cosmetic, a daily necessity, a game, or a toy, that needs to be delivered and accessed by the public.

Step S103: searching for at least one piece of candidate material content matching the target object according to the keyword and displaying the at least one piece of candidate material content in a content expression region of the content editing page in a form of a card, where the candidate material content includes video content and text content.

The content editing tool queries the corresponding content from a material database accessed by the content editing tool according to the keyword of the target object to obtain the delivered material content including at least one keyword, and determines the delivered material content as the candidate material content.

The content expression region is a region for displaying the candidate material content, and the candidate material content includes video content and text content corresponding to the video content. The video content and the text content in the candidate material content are packaged in the form of a card, ensuring that each piece of candidate material content has one card and ensuring a close association between the video content and the text content. Then, the cards formed by each piece of candidate material content are displayed in different positions of the content expression region, so that the user may view multiple pieces of candidate material content at the same time for easy comparison, so as to get inspiration for generating delivery content for the target object.

Step S104: extracting target material content matching the target object in response to a view operation for the candidate material content in the card.

The view operation is an operation for the user to view each piece of candidate material content. Specifically, for any piece of candidate material content, the content editing page may respond to the user's view operation to play the corresponding video content in the card of the candidate material content, as shown in FIG. 3. In the process of playing the video content, the corresponding text content is synchronously displayed in the card, so that the corresponding browsing of the video content and the text content may be realized in the same card. By browsing each piece of candidate material content, the user may extract information such as text content or a video shooting mode adapted to the target object from the candidate material content according to the actual characteristics of the target object, and use the extracted information as the target material content for generating the delivery content for the target object.

According to the material content extraction method provided by this embodiment, by supporting the editing of keywords on the content editing page, the corresponding candidate material content may be searched for by using the keywords, and the matching degree between the candidate material content and the keywords is ensured. By displaying each piece of candidate material content in the content expression region in the form of a card, the information carried by the candidate material content can be better organized, the information integrity of the candidate material content is ensured, and it is convenient for users to get inspiration from it. At the same time, displaying each piece of candidate material content in the form of a card is beneficial to improving the screen utilization. Then, by viewing the candidate material content in the card, it is convenient for the user to make a comparison and reference to extract inspiration from it, and obtain the target material content that matches the target object most. In this way, the visual extraction of the material content is realized, the efficiency of implementing the material content is greatly improved, and it is convenient for the user to effectively edit the delivery content of the target object according to the target material content, which helps to improve the delivery effect of the target object.

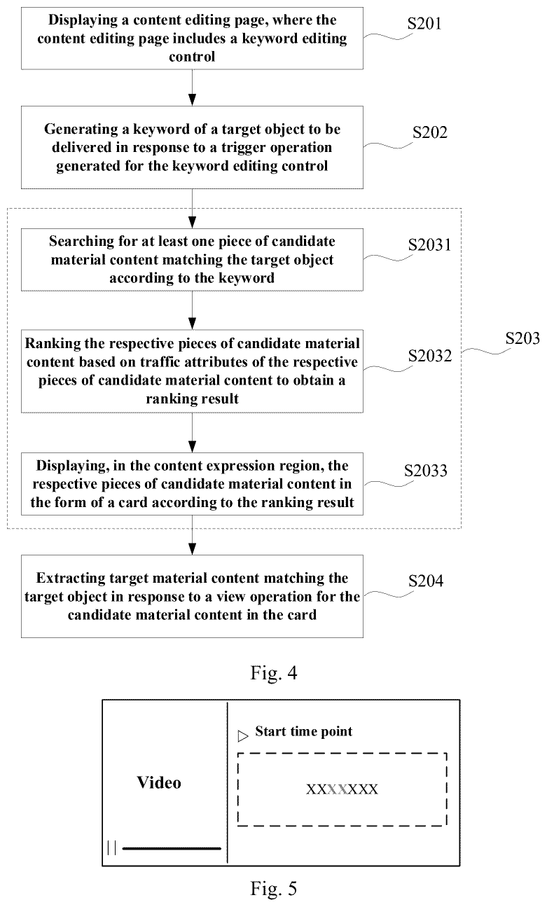

In this embodiment, a material content extraction method is provided, which may be applied to computer devices, such as mobile phones, tablets, computers, etc. FIG. 4 is a flowchart of a material content extraction method according to an embodiment of the present disclosure. As shown in FIG. 4, the process includes the following steps.

Step S201: displaying a content editing page, where the content editing page includes a keyword editing control. For details, please refer to the relevant description of the corresponding step in the embodiment shown above, which will not be repeated here.

Step S202: generating a keyword of a target object to be delivered in response to a trigger operation generated for the keyword editing control. For details, please refer to the relevant description of the corresponding step in the embodiment shown above, which will not be repeated here.

Step S203: searching for at least one piece of candidate material content matching the target object according to the keyword and displaying the at least one piece of candidate material content in a content expression region of the content editing page in a form of a card, where the candidate material content includes video content and text content.

Specifically, the above step S203 includes:

Step S2031: searching for at least one piece of candidate material content matching the target object according to the keyword. For details, please refer to the relevant description of the corresponding step in the embodiment shown above, which will not be repeated here.

Step S2032: ranking the respective pieces of candidate material content based on traffic attributes of the respective pieces of candidate material content to obtain a ranking result.

The traffic attribute is used to characterize the traffic possessed by the visual material of the candidate material content, and may specifically include a click through rate, material consumption, the number of materials, etc. The availability of the expression content carried in each piece of candidate material content with respect to the target object is determined by analyzing the traffic attribute of each piece of candidate material content, and the core value content carried by the candidate material content is represented by the availability, so that the respective pieces of candidate material content may be ranked according to the availability to obtain a ranking result of availability from high to low.

Step S2033: displaying, in the content expression region, the respective pieces of candidate material content in the form of a card according to the ranking result.

The display position is the position of the candidate material content in the content expression region. Specifically, the content expression region includes at least one display page, and a preset number of pieces of candidate material content may be arranged on each display page. In order to ensure the display effect of the candidate material content, the preset number of pieces of candidate material content that may be arranged on each display page may be determined according to actual needs, which is not specifically limited here. After determining the ranking result of the respective pieces of candidate material content, the respective pieces of candidate material content are arranged in the content expression region in the order of ranking from high to low.

The content expression region supports pagination, that is, each page supports placing a preset number of pieces of candidate material content. After exceeding the preset number, the remaining candidate material content may be arranged on the next page, and so on, until all the candidate material content is completely arranged.

In some optional implementations, the above step S2033 includes:
Step a1: acquiring a layout mode of the content expression region.
Step a2: displaying, in the content expression region, the respective pieces of candidate material content in the form of a card based on the ranking result and the layout mode.

The layout mode is the arrangement mode of the candidate material content in the content expression region, such as a three-column two-row layout; a two-column three-row layout, etc. The layout mode may be flexibly determined according to the size of the content expression region, which is not specifically limited here.

After the layout mode is determined, the position and number of candidate material content that may be displayed in the content expression region may be determined. Based on the layout mode of the content expression region, the respective pieces of candidate material content are successively arranged in respective display positions in the content expression region according to the ranking result.

In the above implementation, each piece of candidate material content is displayed based on the layout mode of the content expression region and the ranking result of the candidate material content, which facilitates the rational use of the space of the content expression region. At the same time, the ranking information of each piece of candidate material content may be displayed to the user, which facilitates the user to fully understand the traffic-driving performance of each piece of candidate material content to assist the user in selecting the candidate material content.

In some optional implementations, the displaying, in the content expression region, the respective pieces of candidate material content in the form of a card includes:
Step b1: determining, for any piece of candidate material content, a target card corresponding to the candidate material content.
Step b2: displaying the video content corresponding to the candidate material content in a first preset position of the target card and displaying the text content in a second preset position of the target card, where the keyword is displayed in the text content in a preset manner, and the first preset position is adjacent to the second preset position.

As described above, the video content and the text content of each piece of candidate material content are displayed in the form of a card, therefore, any piece of candidate material content has a corresponding target card. The first preset position is a preset position for displaying the video content, such as the left side of the target card, as shown in FIG. 5; the second preset position is a preset position for displaying the text content, such as the right side of the target card, as shown in FIG. 5.

In order to highlight the display of the keyword of the target object in the text content, the keyword is displayed in a preset manner that is different from other non-keywords. The preset manner may be bold, a color highlight, a different font color, or a combination of bold and color highlight. The preset manner is not specifically limited here, and may be determined by those skilled in the art according to actual needs. As shown in FIG. 5, the keyword is highlighted in the text content in a combination of bold and color highlight.

In the above implementation, the video content and the text content are respectively displayed in adjacent positions in the card, which ensures a close association between the video content and the text content, enables the user to capture key information at a glance, and is beneficial for the user to obtain inspiration efficiently.

In some optional implementations, the above method may further include:
Step c1: acquiring a start time point at which the text content appears in the video content.
Step c2: displaying the start time point in a third preset position of the target card.
Step c3: playing the video content from the start time point in response to a trigger operation for the start time point.

The start time point is the time point at which the text content is mentioned in the video content. Specifically, by parsing the correspondence between the video content and the text content, the video frame corresponding to the text content may be identified, so that the start time point at which the text content appears in the video content may be determined according to the position of the video frame in the video content.

The third preset position is a preset position for displaying the start time point, for example, above the text content, as shown in FIG. 5. Certainly, it may also be displayed below the text content, which is not specifically limited here.

When the user triggers the start time point displayed in the third preset position, the target card responds to the user's trigger operation on the start time point, so that the video content jumps to the start time point for playing.

In the above implementation, by displaying the start time point in the target card, the user may directly jump to the corresponding position to play the video content when clicking on the start time point, which facilitates the user to directly locate the video clip corresponding to the text content, saves video browsing time, and improves browsing efficiency.

In some optional implementations, the above method may further include: displaying a position at which the text content appears on a playback progress component of the video content.

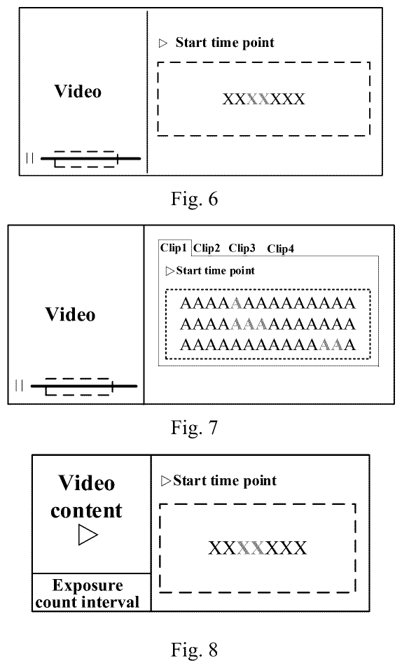

The playback progress component is a component that displays the video playback progress, such as the playback progress bar shown in FIG. 6. In the process of jumping to the start time point to play the video content, the playback progress component is displayed, and the playback progress of the video content is displayed through the playback progress component, and at the same time, the position at which the text content appears in the video content is displayed on the playback progress component. For example, a line box is used to demarcate a segment from the start time point to the end time point of the text content on the playback progress bar, as shown in FIG. 6.

In the above implementation, by displaying the position at which the text content appears on the playback progress component, the user may intuitively determine the position at which the text content appears in the video content, which facilitates the user to view or play the corresponding video clip according to the position at which the text content appears.

In some optional implementations, the above method may further include:
Step d1: identifying whether the number of characters of the text content exceeds a preset value.
Step d2: if the number of characters of the text content exceeds the preset value, truncating the text content to generate multiple text segments carrying the keyword, and displaying the respective text segments in the second preset position in pages.

The preset value is a preset upper limit value of number of characters that may be displayed. After the text content of the candidate material content is acquired, the number of characters in the text content is counted to determine whether the number of characters contained therein exceeds the preset value. If the number of characters of the text content exceeds the preset value, the text content is truncated according to the position at which the keyword appears and the semantics represented by the text content to obtain multiple text segments carrying the keyword, and it is ensured that the number of characters of each text segment does not exceed the preset value. Then, each text segment is displayed in the second preset position in pages, and the user may switch pages to view the text segments, as shown in FIG. 7. At the same time, when switching the text segments, the start time point displayed in the third preset position is dynamically updated with the display of the text segments.

In the above implementation, by identifying the number of characters of the text content and truncating the text content after the number of characters exceeds the preset value to obtain multiple text segments containing the keyword, each text segment is displayed in pages. Compared with directly presenting the complete long text content (including content irrelevant to the keyword), this method may refine the key information more accurately, facilitate the user to obtain inspiration efficiently, and provide a more focused reference for the subsequent generation of delivery content, thereby greatly improving the practicability of the displayed text content.

In some optional implementations, the traffic attribute includes the exposure count, and the exposure count represents the number of times the candidate material content is viewed by the public. Accordingly, the above method further includes:
Step e1: acquiring the exposure count corresponding to each piece of candidate material content and determining an exposure count interval matching the exposure count.
Step e2: displaying the exposure count interval on a cover corresponding to the candidate material content.

For each piece of published candidate material content, the frequency or degree to which it is viewed or clicked by the public may be counted in real time to obtain the corresponding exposure count. After acquiring the exposure count corresponding to each piece of candidate material content, each exposure count is binned, and the exposure count interval matching each exposure count is determined, and the exposure count interval is displayed on the cover corresponding to the candidate material content, which may be a video cover of the video content, as shown in FIG. 8.

In the above implementation, by displaying the exposure count in intervals, the privacy of the exposure count of the candidate material content is ensured. By displaying the exposure count interval, it is convenient to assist the user to select the material content he/she needs according to actual needs.

Step S204: extracting target material content matching the target object in response to a view operation for the candidate material content in the card. For details, please refer to the relevant description of the corresponding step in the embodiment shown above, which will not be repeated here.

According to the material content extraction method provided by this embodiment, by ranking each piece of candidate material content based on the traffic attribute of the candidate material content and displaying each piece of candidate material content in the content expression region in the form of a card according to the ranking result, the user is ensured to quickly locate the candidate material content with high traffic, and the capture rate of key information is improved.

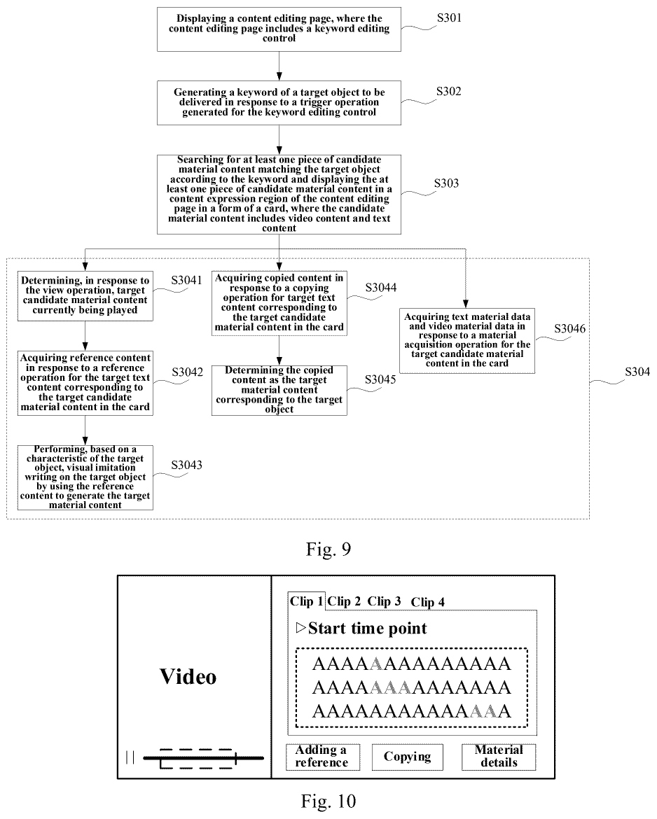

In this embodiment, a material content extraction method is provided, which may be applied to computer devices, such as mobile phones, tablets, computers, etc. FIG. 9 is a flowchart of a material content extraction method according to an embodiment of the present disclosure. As shown in FIG. 9, the process includes the following steps.

Step S301: displaying a content editing page, where the content editing page includes a keyword editing control. For details, please refer to the relevant description of the corresponding step in the embodiment shown above, which will not be repeated here.

Step S302: generating a keyword of a target object to be delivered in response to a trigger operation generated for the keyword editing control. For details, please refer to the relevant description of the corresponding step in the embodiment shown above, which will not be repeated here.

Step S303: searching for at least one piece of candidate material content matching the target object according to the keyword and displaying the at least one piece of candidate material content in a content expression region of the content editing page in a form of a card, where the candidate material content includes video content and text content. For details, please refer to the relevant description of the corresponding step in the embodiment shown above, which will not be repeated here.

Step S304: extracting target material content matching the target object in response to a view operation for the candidate material content in the card.

Specifically, the above step S304 includes:

Step S3041: determining, in response to the view operation, target candidate material content currently being played.

When the user browses and views each piece of candidate material content, he/she will trigger the playback of the candidate material content he/she currently wants to view. Since only one piece of candidate material content is played at the same time, after responding to the view operation triggered by the user for the candidate material content, the playing state of each piece of candidate material content may be detected, and the target candidate material content currently in the playing state may be selected therefrom.

Step S3042: acquiring reference content in response to a reference operation for target text content corresponding to the target candidate material content in the card.

The reference operation is an operation of selecting the text content as a reference. Specifically, as shown in FIG. 10, an add reference control is provided on the card corresponding to each piece of candidate material content, and accordingly, by triggering the add reference control on the card where the target candidate material content is located, the target text content corresponding to the target candidate material content may be added as the reference content of the target object.

Step S3043: performing, based on a characteristic of the target object, visual imitation writing on the target object by using the reference content to generate the target material content.

The characteristic of the target object is a unique attribute of the target object, such as an application scenario of the target object, a function of the target object, and a use effect of the target object. According to the characteristic of the target object, the reference content is used for imitation writing to generate the corresponding target material content.

According to the material content extraction method provided by this embodiment, when the target candidate material content is viewed, the target text content in the target candidate material content may be conveniently selected as a reference, so that the reference content may be used for imitation writing, the cost of manual rewriting may be reduced, the efficient implementation of the text material may be promoted, a closed loop from inspiration to application may be realized, and the coherence and delivery efficiency of the delivery workflow may be improved.

In some optional implementations, the above method further includes:
Step f1: generating a dynamic prompt of successful reference when the reference content is successfully acquired.
Step f2: displaying, in a fourth preset position of the content editing page, reference information for the reference content.

When the user triggers the add reference control and successfully acquires the reference content, the corresponding dynamic prompt is generated on the card corresponding to the target candidate material content, so that the dynamic prompt represents a successful reference. At the same time, the reference information corresponding to the reference content is displayed in the fourth preset position of the content editing page, where the fourth preset position is a preset position for displaying the reference information, such as below the content expression region; the reference information is information generated for the reference content, and the information may be summary information of the reference content or brief information of the reference content, which is not specifically limited here, as long as it may represent the reference content.

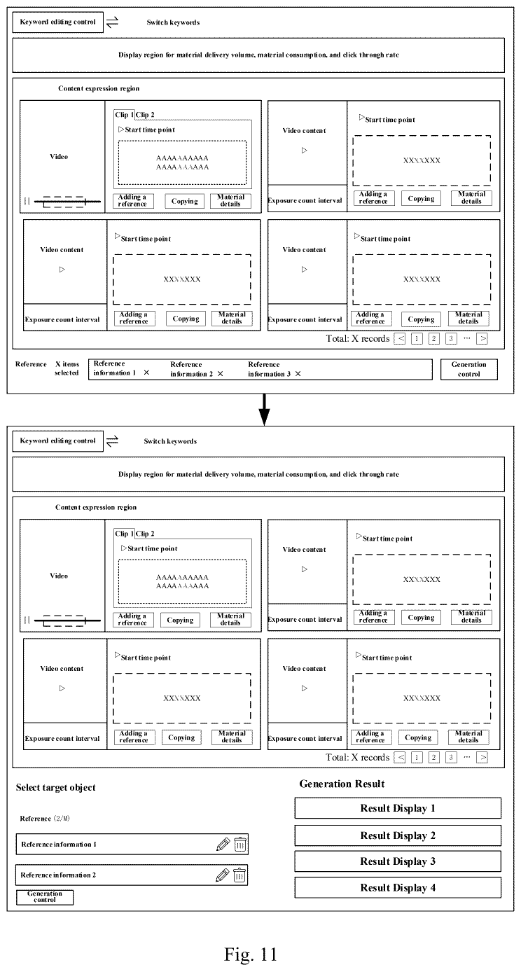

As shown in FIGS. 10 and 11, after the add reference control is clicked, a blue dot dynamic effect appears, prompting that the text content corresponding to the target candidate material content has been added to the text generation reference for the target object, and the reference information for the reference content is displayed in a bottom floating layer below the content expression region.

According to the material content extraction method provided by this embodiment, the dynamic prompt is used to represent the successful acquisition of the reference content, and the reference information of the reference content is displayed in the corresponding position of the content editing page, which facilitates the user to intuitively understand the reference content he/she selected.

In some optional implementations, the above method further includes:
Step g1: in response to a delete operation for the reference information, deleting, according to the delete operation, the reference information of the target object to obtain target reference information.
Step g2: in response to a visual generation operation for the target object, generating, according to the target reference information, the target material content of the target object.

After completing the acquisition of the reference content, the user may delete the reference information according to actual needs to realize the adjustment of the reference content. As shown in FIG. 10, each piece of reference information corresponds to a corresponding delete control, and the user may click the delete control to perform the delete operation on the reference information. Accordingly, the content editing page may respond to the delete operation triggered by the user and delete the corresponding reference information according to the delete operation to obtain the target reference information that meets the requirements.

A corresponding content generation control is provided in the display position of the reference information. After the target reference information is determined, the content generation control is clicked, and the content generation is automatically performed according to the target reference information to generate the target material content of the target object and display it, as shown in FIG. 11.

According to the material content extraction method provided by this embodiment, the deletion of the reference information is supported, which facilitates the user to flexibly adjust the reference information he/she needs, and improves the quality of the generated target material content.

In some optional implementations, the above step S304 may further include:

Step S3044: acquiring copied content in response to a copying operation for the target text content corresponding to the target candidate material content in the card.

Step S3045: determining the copied content as the target material content corresponding to the target object.

The copying operation is an operation of copying the text content. Specifically, as shown in FIG. 10, a copying control is provided on the card corresponding to each piece of candidate material content, and accordingly, by triggering the copying control on the card where the target candidate material content is located, the target text content corresponding to the target candidate material content may be copied to obtain the corresponding copied content.

Specifically, if it is determined that the target text content corresponding to the target candidate material content is the required text content, the user may directly click the copying control to quickly acquire the target text content, and use the target text content as the target material content for subsequent material generation.

According to the material content extraction method provided by this embodiment, when the target candidate material content is viewed, the target text content in the target candidate material content may be conveniently copied to be used as the target material content, which reduces the cost of manual editing and greatly improves the efficiency of implementing the text material.

In some optional implementations, the above step S304 may further include:

Step S3046: acquiring text material data and video material data in response to a material acquisition operation for the target candidate material content in the card.

The material acquisition operation is an operation of extracting the material included in the target candidate material content. Specifically, as shown in FIG. 10, a material details control is provided on the card corresponding to each piece of candidate material content, and accordingly, by triggering the material details control on the card where the target candidate material content is located, the text material and the video material included in the target candidate material content may be parsed, the corresponding text material data and video material data may be acquired, and the text material data and the video material data may be displayed, so that the user may refer to the text material and the video material to write text and shoot video for the target object.

According to the material content extraction method provided by this embodiment, when the target candidate material content is viewed, the text material data and the video material data in the target candidate material content are supported to be acquired, which ensures a close combination of the text material and the video material, and improves the use efficiency of the material.

In this embodiment, a material content extraction apparatus is further provided. The apparatus is used to implement the above embodiments and preferred implementations, which will not be repeated here. As used below, the term “module” may implement a combination of software and/or hardware for a predetermined function. Although the apparatus described in the following embodiments is preferably implemented in software, implementation in hardware, or a combination of software and hardware is also possible and contemplated.

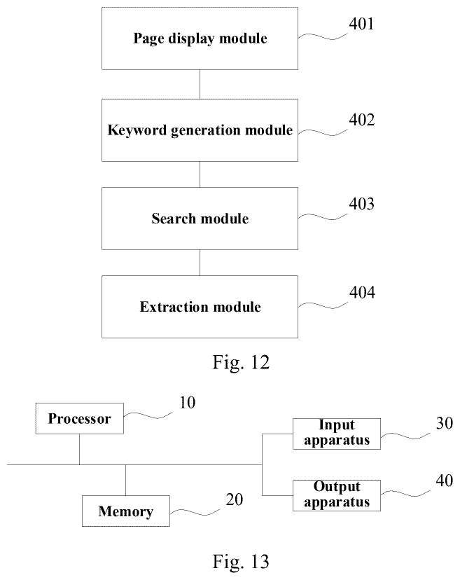

This embodiment provides a material content extraction apparatus, as shown in FIG. 12, including:
a page display module 401, configured to display a content editing page, where the content editing page includes a keyword editing control;
a keyword generation module 402, configured to generate a keyword of a target object to be delivered in response to a trigger operation generated for the keyword editing control;
a search module 403, configured to search for at least one piece of candidate material content matching the target object according to the keyword and display the at least one piece of candidate material content in a content expression region of the content editing page in a form of a card, where the candidate material content includes video content and text content; and
an extraction module 404, configured to extract target material content matching the target object in response to a view operation for the candidate material content in the card.

In some optional implementations, the search module 403 includes:
a ranking unit, configured to rank respective pieces of candidate material content based on traffic attributes of the respective piece of candidate material content to obtain a ranking result; and
a display unit, configured to display, according to the ranking result, the respective piece of candidate material content in the content expression region in the form of a card.

In some optional implementations, the traffic attribute includes the exposure count, and accordingly, the above search module 403 further includes:
an exposure count acquiring unit, configured to acquire the exposure count corresponding to each piece of candidate material content and determine an exposure count interval matching the exposure count; and
an exposure count display unit, configured to display the exposure count interval on a cover corresponding to the candidate material content.

In some optional implementations, the display unit includes:
a layout acquiring subunit, configured to acquire a layout mode of the content expression region; and
a display subunit, configured to display, in the content expression region, the respective pieces of candidate material content in the form of a card based on the ranking result and the layout mode.

In some optional implementations, the display subunit is further specifically configured to, for any piece of candidate material content, determine a target card corresponding to the candidate material content; and display the video content corresponding to the candidate material content in a first preset position of the target card and display the text content in a second preset position of the target card, where the keyword is displayed in the text content in a preset manner, and the first preset position is adjacent to the second preset position.

In some optional implementations, the display subunit is further specifically configured to acquire a start time point at which the text content appears in the video content; display the start time point in a third preset position of the target card; and play the video content from the start time point in response to a trigger operation for the start time point.

In some optional implementations, the display subunit is further specifically configured to display a position at which the text content appears on a playback progress component of the video content.

In some optional implementations, the display unit further includes:
an identification subunit, configured to identify whether the number of characters of the text content exceeds a preset value; and
a truncation subunit, configured to, if the number of characters of the text content exceeds the preset value, truncate the text content to generate multiple text segments carrying the keyword, and display the respective text segments in the second preset position in pages.

In some optional implementations, the extraction module 404 includes:
a target determination unit, configured to determine, in response to the view operation, target candidate material content currently being played;
a first content acquisition unit, configured to acquire reference content in response to a reference operation for target text content corresponding to the target candidate material content in the card; and
a first generation unit, configured to perform, based on a characteristic of the target object, visual imitation writing on the target object by using the reference content to generate the target material content.

In some optional implementations, the above extraction module 404 further includes:
a dynamic prompt unit, configured to generate a dynamic prompt of successful reference when the reference content is successfully acquired; and
a reference display unit, configured to display, in a fourth preset position of the content editing page, reference information for the reference content.

In some optional implementations, the above extraction module 404 further includes:
a deletion unit, configured to, in response to a delete operation for the reference information, delete, according to the delete operation, the reference information of the target object to obtain target reference information; and
a material content generation unit, configured to, in response to a material generation operation for the target object, generate, according to the target reference information, the target material content of the target object.

In some optional implementations, the above extraction module 404 further includes:
a copying unit, configured to acquire copied content in response to a copying operation for the target text content corresponding to the target candidate material content in the card; and
a second generation unit, configured to determine the copied content as the target material content corresponding to the target object.

In some optional implementations, the above extraction module 404 further includes:
a material acquisition unit, configured to acquire text material data and video material data in response to a material acquisition operation for the target candidate material content in the card.

Further functional descriptions of the above modules and units are the same as those in the corresponding embodiments above, and will not be repeated here.

The material content extraction apparatus in this embodiment is presented in a form of functional units, and the unit here refers to an ASIC (Application Specific Integrated Circuit) circuit, a processor and a memory that execute one or more software or fixed programs, and/or other devices that may provide the above functions.

According to the material content extraction apparatus provided by this embodiment, by supporting the editing of keywords on the content editing page, the corresponding candidate material content may be searched for by using the keywords, and the matching degree between the candidate material content and the keywords is ensured. By displaying each piece of candidate material content in the content expression region in the form of a card, the information carried by the candidate material content can be better organized, the information integrity of the candidate material content is ensured, and it is convenient for users to get inspiration from it. At the same time, displaying each piece of candidate material content in the form of a card is beneficial to improving the screen utilization. Then, by viewing the candidate material content in the card, it is convenient for the user to make a comparison and reference to extract inspiration from it, and obtain the target material content that matches the target object most. In this way, the visual extraction of the material content is realized, the efficiency of implementing the material content is greatly improved, and it is convenient for the user to effectively edit the delivery content of the target object according to the target material content, which helps to improve the delivery effect of the target object.

An embodiment of the present disclosure further provides a computer device having the material content extraction apparatus shown in FIG. 12 above.

Referring to FIG. 13, FIG. 13 is a structural schematic diagram of a computer device provided by an optional embodiment of the present disclosure. As shown in FIG. 13, the computer device includes: one or more processors 10, a memory 20, and interfaces for connecting various components, including high-speed interfaces and low-speed interfaces. The components communicate with each other using different buses and may be installed on a common main board or in other ways as needed. The processor may process instructions executed within the computer device, including instructions stored in or on the memory to display graphical information of GUI on an external input/output apparatus (such as a display device coupled to the interface). In some optional implementations, if required, multiple processors and/or buses may be used with multiple memories and multiple memories. Similarly, multiple computer devices may be connected, and each device provides some necessary operations (for example, as a server array, a group of blade servers, or a multi-processor system). In FIG. 13, one processor 10 is taken as an example.

The processor 10 may be a central processing unit, a network processor, or a combination thereof. The processor 10 may further include a hardware chip. The above hardware chip may be an application specific integrated circuit, a programmable logic device, or a combination thereof. The above programmable logic device may be a complex programmable logic device, a field programmable logic gate array, a generic array logic, or any combination thereof.

The memory 20 stores instructions executable by the at least one processor 10, so that the at least one processor 10 executes the method shown in the above embodiments.

The memory 20 may include a program storage area and a data storage area, where the program storage area may store an application program required by an operating system and at least one function; the data storage area may store data created according to the use of the computer device, etc. In addition, the memory 20 may include a high-speed random access memory or a non-transitory memory, such as at least one magnetic disk storage device, a flash memory device, or other non-transitory solid-state storage devices. In some optional implementations, the memory 20 optionally includes memories remotely provided with respect to the processor 10, and these remote memories may be connected to the computer device through a network. Examples of the above network include, but are not limited to, Internet, an intranet, a local area network, a mobile communication network, and a combination thereof.

The memory 20 may include a volatile memory, such as a random access memory; the memory may also include a non-volatile memory, such as a flash memory, a hard disk or a solid-state disk; the memory 20 may further include a combination of the above kinds of memories.

The computer device further includes an input apparatus 30 and an output apparatus 40. The processor 10, the memory 20, the input apparatus 30, and the output apparatus 40 may be connected through a bus or in other ways. In FIG. 13, connection through a bus is used as an example.

The input apparatus 30 may receive input digital or character information, and generate a key signal input related to user settings and function control of the computer device, such as a touch screen, a keypad, a mouse, a track pad, a touch panel, an indicator stick, one or more mouse buttons, a trackball, a joystick, etc. The output apparatus 40 may include a display device, an auxiliary lighting apparatus (such as an LED), a tactile feedback apparatus (such as a vibration motor), etc. The above display device includes, but is not limited to, a liquid crystal display, a light emitting diode, a display, and a plasma display. In some optional implementations, the display device may be a touch screen.

The computer device further includes a communication interface for the computer device to communicate with other devices or communication networks.

An embodiment of the present disclosure further provides a computer-readable storage medium. The method according to the embodiment of the present disclosure may be implemented in hardware and firmware, or implemented as computer code that may be recorded in a storage medium or originally stored in a remote storage medium or a non-transitory machine-readable storage medium and downloaded through a network and will be stored in a local storage medium. Thus, the method described herein may be stored in such software on a storage medium using a general-purpose computer, a dedicated processor, or programmable or dedicated hardware for processing. The storage medium may be a magnetic disk, an optical disk, a read-only memory, a random access memory, a flash memory, a hard disk or a solid-state disk, etc. Further, the storage medium may also include a combination of the above kinds of memories. It may be understood that the computer, the processor, the microprocessor controller or the programmable hardware includes a storage component that may store or receive software or computer code. When the software or computer code is accessed and executed by the computer, the processor or the hardware, the method shown in the above embodiments is implemented.

A part of the present disclosure may be applied as a computer program product, such as computer program instructions, which, when executed by a computer, may invoke or provide the method and/or technical solution according to the present disclosure through the operation of the computer. Those skilled in the art should understand that the computer program instructions exist in a computer-readable medium in a form including, but not limited to, a source file, an executable file, an installation package file, etc. Accordingly, the computer program instructions are executed by the computer in a manner including, but not limited to, the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described in combination with the drawings, those skilled in the art may make various modifications and variations without departing from the spirit and scope of the present disclosure, and such modifications and variations fall within the scope defined by the appended claims.

1. A material content extraction method, comprising:
displaying a content editing page, wherein the content editing page comprises a keyword editing control;
generating a keyword of a target object to be delivered in response to a trigger operation generated for the keyword editing control;
searching for at least one piece of candidate material content matching the target object according to the keyword, and displaying the at least one piece of candidate material content in a content expression region of the content editing page in a form of a card, wherein the candidate material content comprises video content and text content; and
extracting target material content matching the target object in response to a view operation for the candidate material content in the card.

2. The method of claim 1, wherein the displaying the at least one piece of candidate material content in the content expression region of the content editing page in the form of a card comprises:
ranking respective pieces of the candidate material content based on traffic attributes of the respective pieces of the candidate material content to obtain a ranking result; and
displaying, based on the ranking result, the respective pieces of the candidate material content in the content expression region in the form of a card.

3. The method of claim 2, wherein the displaying, based on the ranking result, the respective pieces of the candidate material content in the content expression region in the form of a card comprises:
acquiring a layout mode of the content expression region; and
displaying, based on the ranking result and the layout mode, the respective pieces of the candidate material content in the content expression region in the form of a card.

4. The method of claim 2, wherein the traffic attribute comprises an exposure count, and the method further comprises:
acquiring the exposure count corresponding to each piece of the candidate material content and determining an exposure count interval matching the exposure count; and
displaying the exposure count interval on a cover corresponding to the candidate material content.

5. The method of claim 2, wherein the displaying the respective pieces of the candidate material content in the form of a card comprises:
determining, for any piece of the candidate material content, a target card corresponding to the candidate material content; and
displaying the video content corresponding to the candidate material content in a first preset position of the target card and displaying the text content in a second preset position of the target card, wherein the keyword is displayed in the text content in a preset manner, and the first preset position is adjacent to the second preset position.

6. The method of claim 5, further comprising:
acquiring a start time point at which the text content appears in the video content;
displaying the start time point in a third preset position of the target card; and
playing the video content from the start time point in response to a trigger operation for the start time point.

7. The method of claim 6, further comprising:
displaying a position at which the text content appears on a playback progress component of the video content.

8. The method of claim 5, further comprising:
identifying whether a number of characters of the text content exceeds a preset value; and
in response to the number of characters of the text content exceeding the preset value, truncating the text content to generate a plurality of text segments carrying the keyword, and displaying the respective text segments in the second preset position in pages.

9. The method of claim 1, wherein the extracting target material content matching the target object in response to a view operation for the candidate material content in the card comprises:
determining, in response to the view operation, target candidate material content currently being played;
acquiring reference content in response to a reference operation for target text content corresponding to the target candidate material content in the card; and
performing, based on a characteristic of the target object, visual imitation writing on the target object by using the reference content to generate the target material content.

10. The method of claim 9, further comprising:
generating a dynamic prompt of successful reference when the reference content is successfully acquired; and
displaying, in a fourth preset position of the content editing page, reference information for the reference content.

11. The method of claim 10, further comprising:
in response to a delete operation for the reference information, deleting, according to the delete operation, the reference information of the target object to obtain target reference information; and
in response to a material generation operation for the target object, generating, according to the target reference information, the target material content of the target object.

12. The method of claim 9, wherein the extracting target material content matching the target object in response to a view operation for the candidate material content in the card further comprises:
acquiring copied content in response to a copying operation for the target text content corresponding to the target candidate material content in the card; and
determining the copied content as the target material content corresponding to the target object.

13. The method of claim 9, further comprising:
acquiring text material data and video material data in response to a material acquisition operation for the target candidate material content in the card.

14. A computer device, comprising:
a memory and a processor, wherein the memory and the processor are communicatively connected to each other, the memory stores computer instructions, and the processor executes the computer instructions to implement a material content extraction method, comprising:
displaying a content editing page, wherein the content editing page comprises a keyword editing control;
generating a keyword of a target object to be delivered in response to a trigger operation generated for the keyword editing control;
searching for at least one piece of candidate material content matching the target object according to the keyword, and displaying the at least one piece of candidate material content in a content expression region of the content editing page in a form of a card, wherein the candidate material content comprises video content and text content; and
extracting target material content matching the target object in response to a view operation for the candidate material content in the card.

15. The computer device of claim 14, wherein the displaying the at least one piece of candidate material content in the content expression region of the content editing page in the form of a card comprises:
ranking respective pieces of the candidate material content based on traffic attributes of the respective pieces of the candidate material content to obtain a ranking result; and
displaying, based on the ranking result, the respective pieces of the candidate material content in the content expression region in the form of a card.

16. The computer device of claim 15, wherein the displaying, based on the ranking result, the respective pieces of the candidate material content in the content expression region in the form of a card comprises:
acquiring a layout mode of the content expression region; and
displaying, based on the ranking result and the layout mode, the respective pieces of the candidate material content in the content expression region in the form of a card.

17. The computer device of claim 15, wherein the traffic attribute comprises an exposure count, and the material content extraction method further comprises:
acquiring the exposure count corresponding to each piece of the candidate material content and determining an exposure count interval matching the exposure count; and
displaying the exposure count interval on a cover corresponding to the candidate material content.

18. The computer device of claim 15, wherein the displaying the respective pieces of the candidate material content in the form of a card comprises:
determining, for any piece of the candidate material content, a target card corresponding to the candidate material content; and
displaying the video content corresponding to the candidate material content in a first preset position of the target card and displaying the text content in a second preset position of the target card, wherein the keyword is displayed in the text content in a preset manner, and the first preset position is adjacent to the second preset position.

19. The computer device of claim 18, wherein the material content extraction method further comprises:
acquiring a start time point at which the text content appears in the video content;
displaying the start time point in a third preset position of the target card; and
playing the video content from the start time point in response to a trigger operation for the start time point.

20. A non-transitory computer-readable storage medium, wherein the computer-readable storage medium stores computer instructions, and the computer instructions are used to cause a computer to perform a material content extraction method, comprising:
displaying a content editing page, wherein the content editing page comprises a keyword editing control;
generating a keyword of a target object to be delivered in response to a trigger operation generated for the keyword editing control;
searching for at least one piece of candidate material content matching the target object according to the keyword, and displaying the at least one piece of candidate material content in a content expression region of the content editing page in a form of a card, wherein the candidate material content comprises video content and text content; and
extracting target material content matching the target object in response to a view operation for the candidate material content in the card.
